(19) United States
(12) Patent Application Publication
(10) Pub. No.: US 2023/0350911 A1
(43) Pub. Date: Nov. 2, 2023

(54) TASK CONFIGURATION USING A DYNAMIC DATA PROCESSING STATEMENT

(71) Applicant: Snowflake Inc., Bozeman, MT (US)

(72) Inventors: Marion A. Brown, Spring, TX (US); Keith M. Hoyle, Montgomery, TX (US)

(21) Appl. No.: 17/661,137

(22) Filed: Apr. 28, 2022

(51) Int. Cl. G06F 16/25; G06F 9/48

(52) U.S. Cl. CPC G06F 16/254; G06F 9/4881

(57) ABSTRACT

Provided herein are systems and methods for identity resolution and data enrichment. An example method performed by at least one hardware processor includes retrieving configuration information associated with periodic processing of a database table. The method further includes detecting a task associated with the database table. The task includes transformation logic configured to perform a single call into the database table. A dynamic data processing statement is generated. The dynamic data processing statement includes multiple data processing statements associated with the periodic processing. A modified task is generated based on revising the transformation logic to include the dynamic data processing statement.

### TECHNICAL FIELD

Embodiments of the disclosure relate generally to databases and, more specifically, to task configuration using dynamic data processing statements, such as dynamic structured query language (SQL) statements, that can be used in a cloud computing platform.

### BACKGROUND

Databases are widely used for data storage and access in computing applications. A goal of database storage is to provide enormous sums of information in an organized manner so that it can be accessed, managed, updated, and shared. In a database, data may be organized into rows, columns, and tables. Different database storage systems may be used for storing different types of content, such as bibliographic, full text, numeric, and/or image content. Further, in computing, different database systems may be classified according to the organizational approach of the database. There are many different types of databases, including relational databases, distributed databases, cloud databases, object-oriented and others. The data in such databases can be accessed by various users in an organization or even be used to service public users, such as via a website or an application program interface (API). Both computing and storage resources, as well as their underlying architecture, can play a significant role in achieving desirable database performance.

Tasks can be executed on database data to manipulate or alter the data. Such tasks can be requested by a client account and may manipulate database data to make it more useful for the client account. However, data processing procedures use task-specific, hard-coded procedures which do not provide sufficient flexibility when tasks are applied to data objects that change over time.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a network-based database system in communication with a cloud storage platform, in accordance with some embodiments of the present disclosure.

FIG. 2 is a block diagram illustrating the components of a compute service manager using a task configuration (TC) manager, in accordance with some embodiments of the present disclosure.

FIG. 3 is a block diagram illustrating components of an execution platform, in accordance with some embodiments of the present disclosure.

FIG. 4 is a block diagram of a TC manager in communication with an execution platform, in accordance with some embodiments of the present disclosure.

FIG. 5 is a block diagram of a data processing pipeline, in accordance with some embodiments of the present disclosure.

FIG. 6 is a diagram of a stream object configuration for a table, in accordance with some embodiments of the present disclosure.

FIG. 7 is a diagram of shared views, in accordance with some embodiments of the present disclosure.

FIG. 8 is a diagram of a stream object based on a complex view, in accordance with some embodiments of the present disclosure.

FIG. 9 is a block diagram of a data processing pipeline using a modified task with a dynamic SQL statement, in accordance with some embodiments of the present disclosure.

FIG. 10, FIG. 11, FIG. 12, and FIG. 13 illustrate example modified tasks including transformation logic with dynamic SQL statements, in accordance with some embodiments of the present disclosure.

FIG. 14 is a flow diagram illustrating operations of a database system in performing a method for task configuration, in accordance with some embodiments of the present disclosure.

FIG. 15 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

Reference will now be made in detail to specific example embodiments for carrying out the inventive subject matter. Examples of these specific embodiments are illustrated in the accompanying drawings, and specific details are outlined in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

In the present disclosure, physical units of data that are stored in a data platform—and that make up the content of, e.g., database tables in customer accounts—are referred to as micro-partitions. In different implementations, a data platform may store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and/or the like. If stored internal to the data platform, a given file is referred to herein as an “internal file” and may be stored in (or at, or on, etc.) what is referred to herein as an “internal storage location.” If stored external to the data platform, a given file is referred to herein as an “external file” and is referred to as being stored in (or at, or on, etc.) what is referred to herein as an “external storage location.” These terms are further discussed below.

Computer-readable files come in several varieties, including unstructured files, semi-structured files, and structured files. These terms may mean different things to different people. As used herein, examples of unstructured files include image files, video files, PDFs, audio files, and the like; examples of semi-structured files include JavaScript Object Notation (JSON) files, eXtensible Markup Language (XML) files, and the like; and examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data. Numerous other examples of unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

As used herein, the term “task” includes a data processing function such as user-defined logic (e.g., user-defined logic received from a client account). A task can include one or more SQL statements, which can be executed on database data to manipulate or alter the data. As used herein, the term “dynamic SQL statement” (or “dynamic data processing statement”) indicates a statement that delivers and executes other data processing statements such as SQL statements.

As used herein, the term “table” indicates a mutable bag of rows, supporting time travel up to a retention period. As used herein, the term “view” indicates a named SELECT statement, conceptually similar to a table. In some aspects, a view can be secure, which prevents queries from getting information on the underlying data obliquely. As used herein, the term “materialized view” indicates a view that is eagerly computed rather than lazily (e.g., as a standard view). In some aspects, efficient implementation of materialized views has overlapped with change tracking functionality. As used herein, the term “stream” refers to a table and a timestamp. In some aspects, a stream may be used to iterate over changes to a table. When a stream is read inside a Data Manipulation Language (DML) statement, its timestamp may be transactionally advanced to the greater timestamp of its time interval.

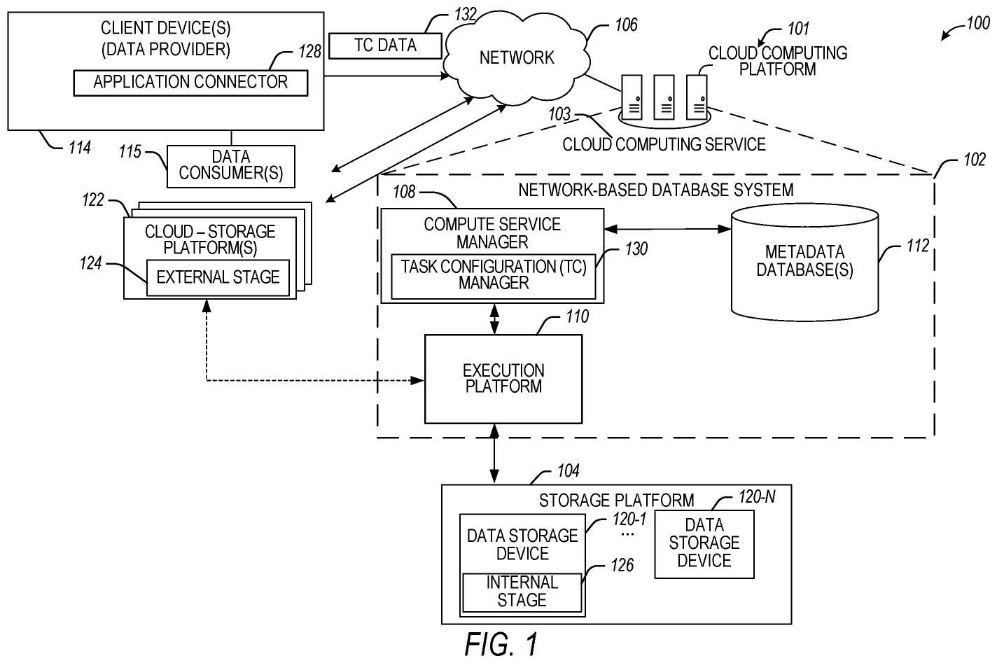

In some aspects, the disclosed task configuration functionalities (e.g., as performed by the disclosed task configuration manager) associated with dynamic data processing statements (e.g., dynamic SQL statements) can exist in a network-based database system (e.g., as illustrated in FIGS. 1-3) or can be leveraged using an existing API (e.g., via one or more external functions). Database processing in the network-based database system can be challenging, especially for databases associated with extract-transform-load (ETL)-based or extract-load-transform (ELT)-based processing. ETL-based or ELT-based processing, change data capture (CDC) using streams, and tasks can be used in connection with task-specific, hard-coded procedures. The disclosed techniques based on dynamic data processing statements (e.g., dynamic SQL statements) can be used to extend the task's functionalities for dynamic, extensible, table-driven data manipulations instead of the hard-coded solutions and procedures. In this regard, the task's functionalities can be extended from performing a single data processing call to periodic execution of multiple data processing calls including performing tasks on data objects that change over time.

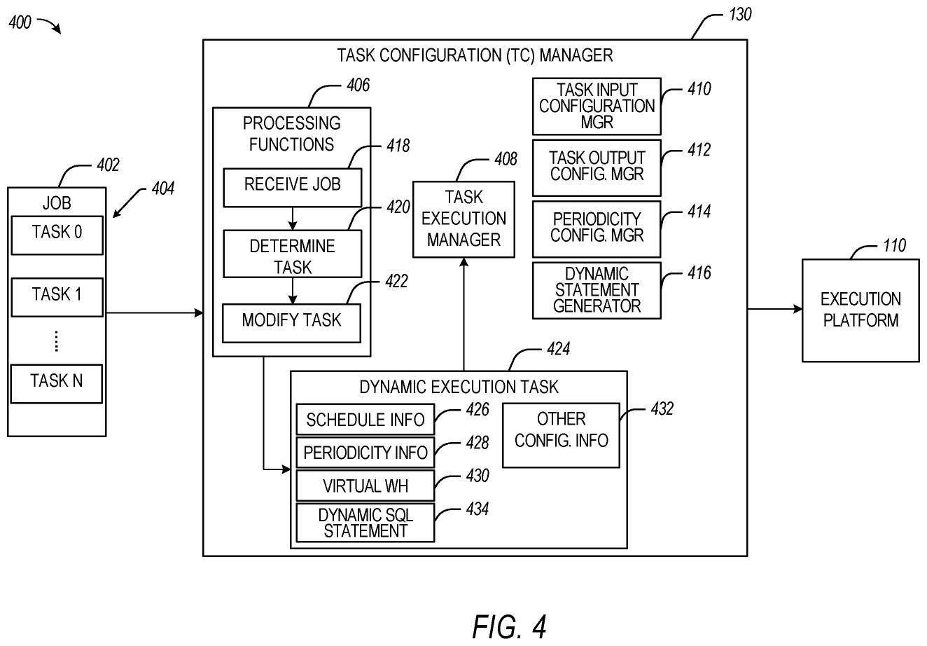

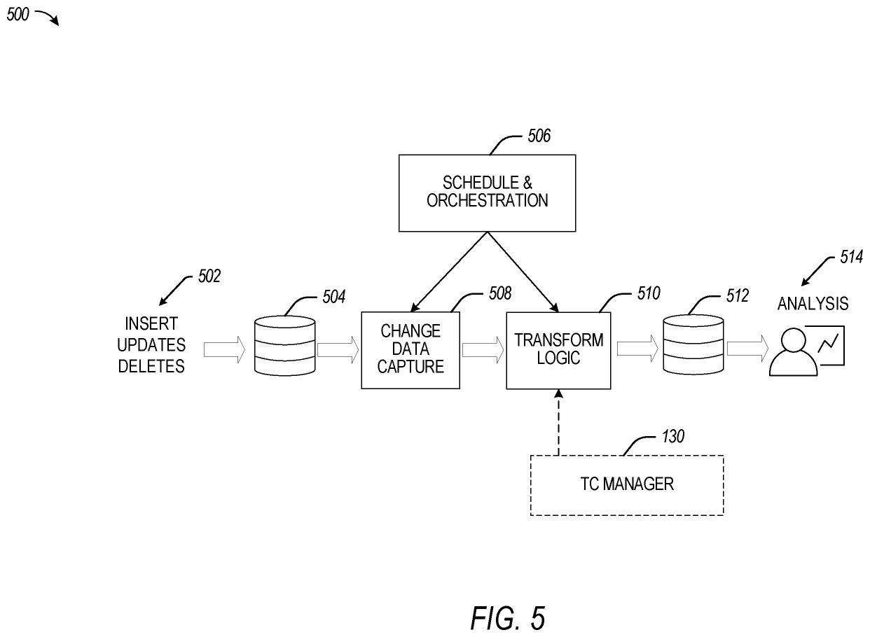

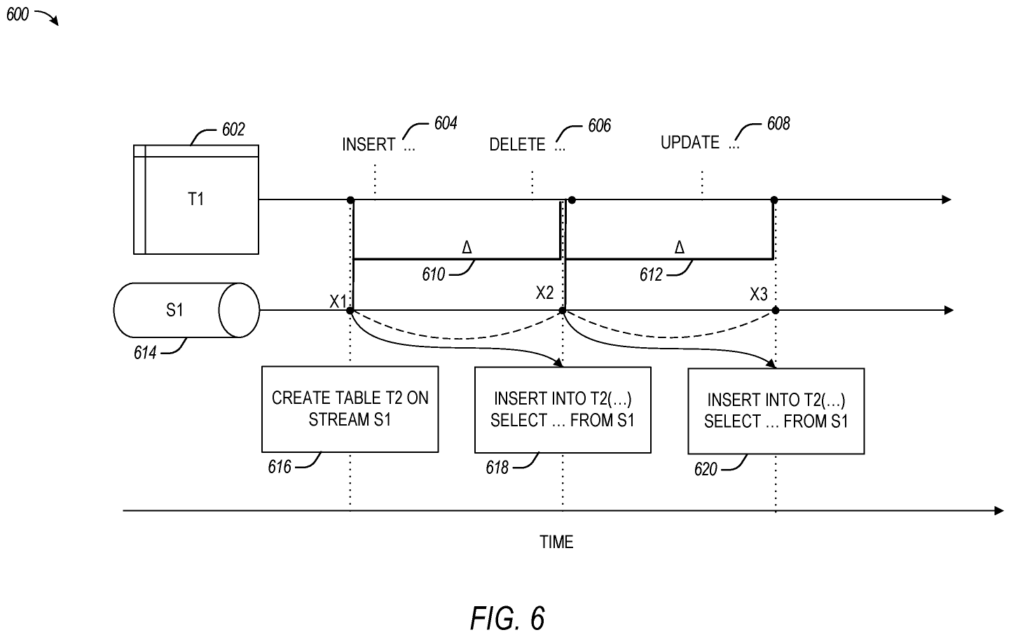

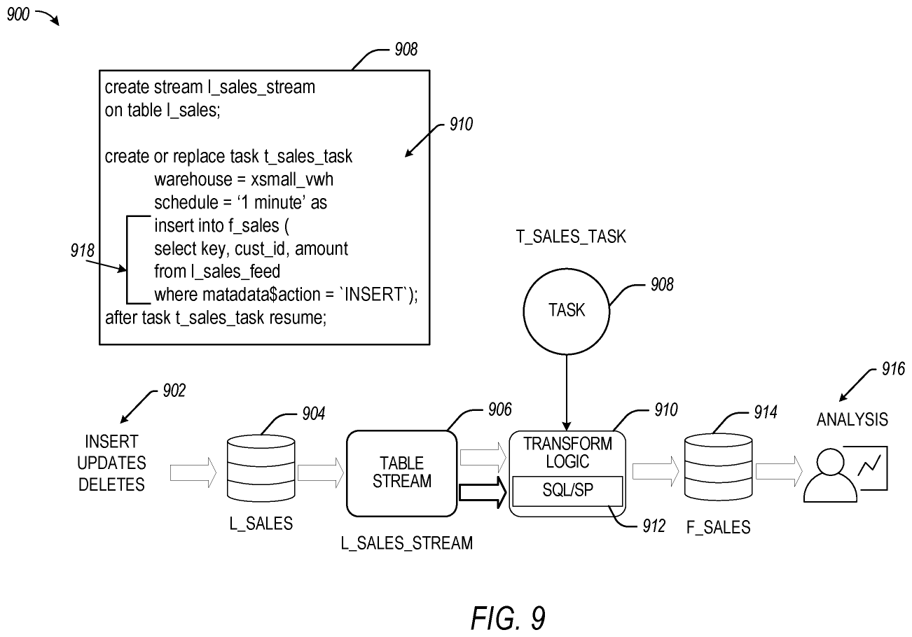

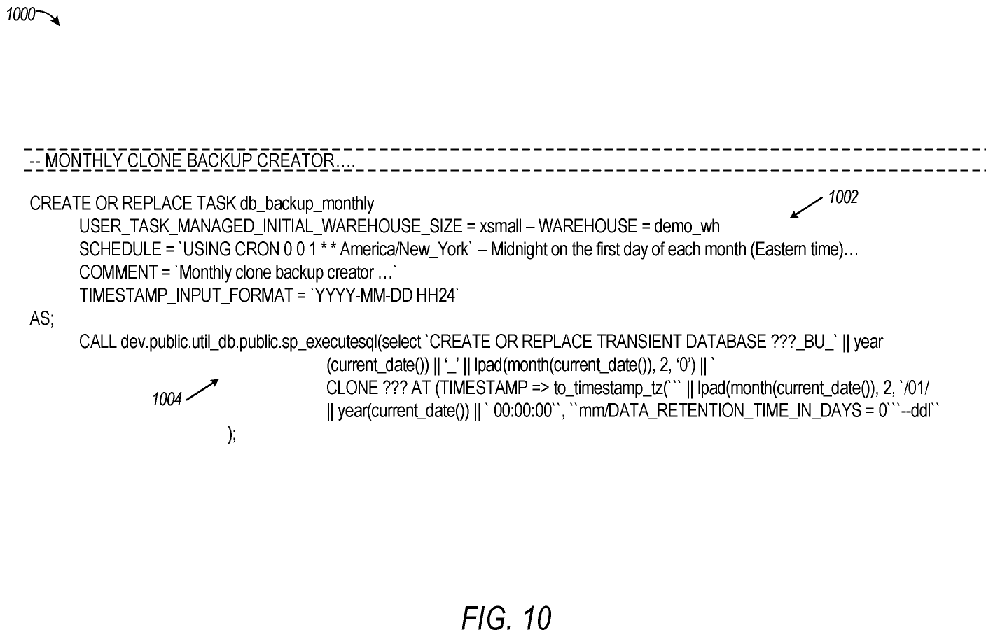

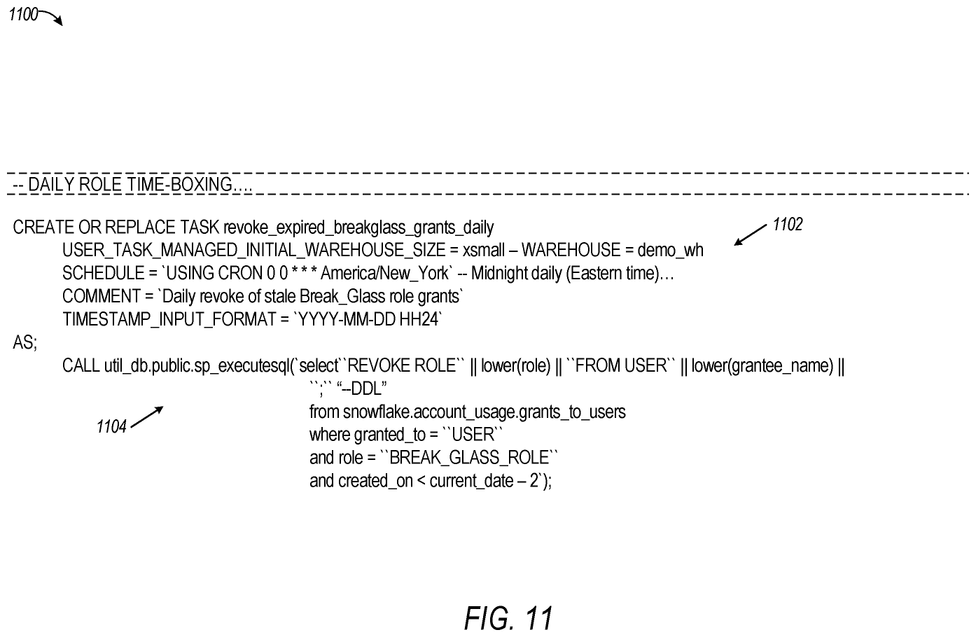

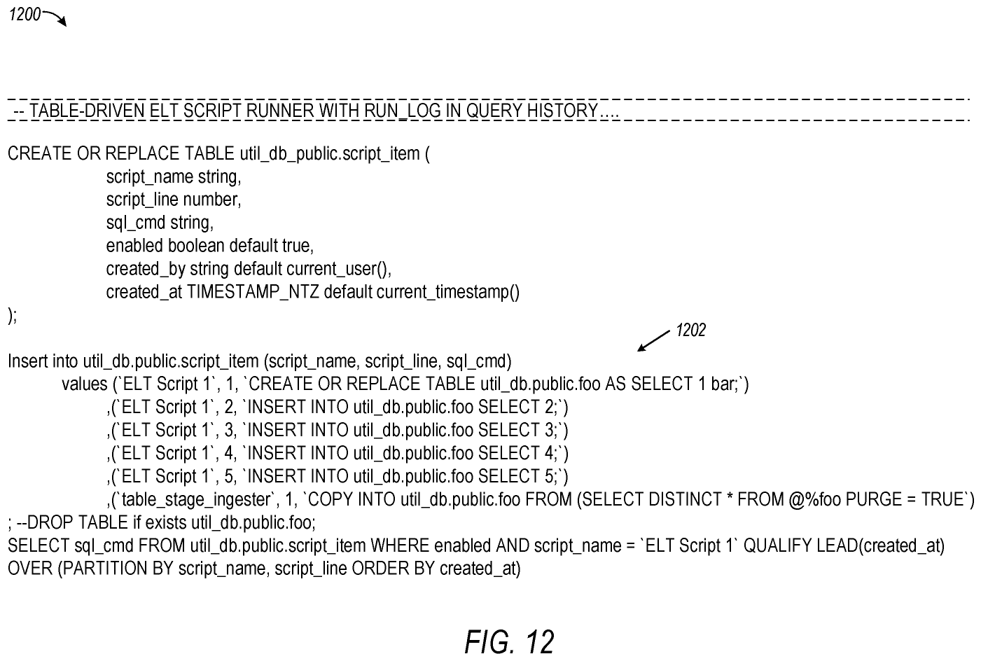

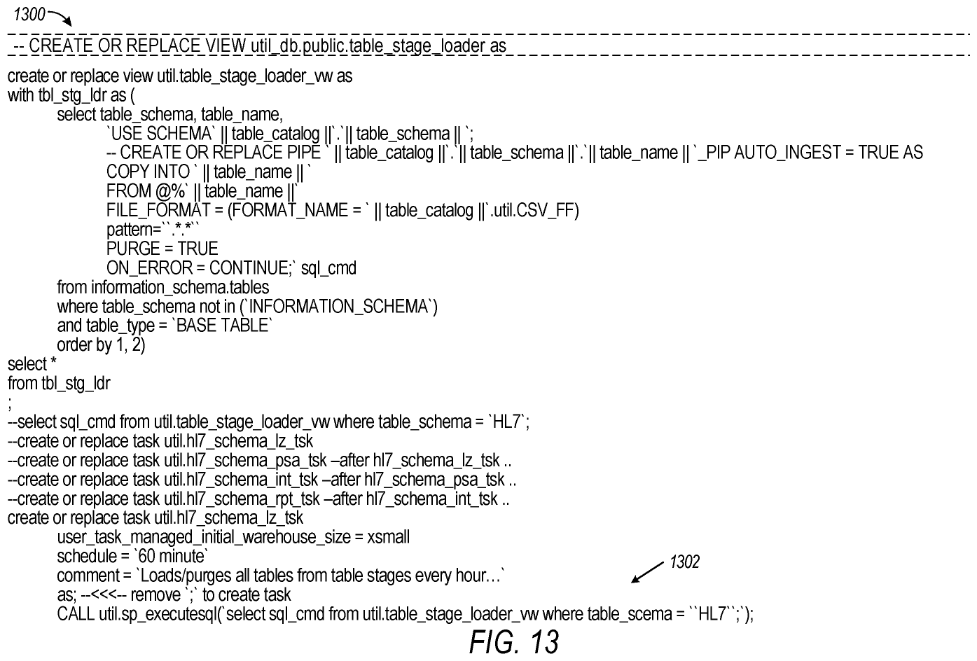

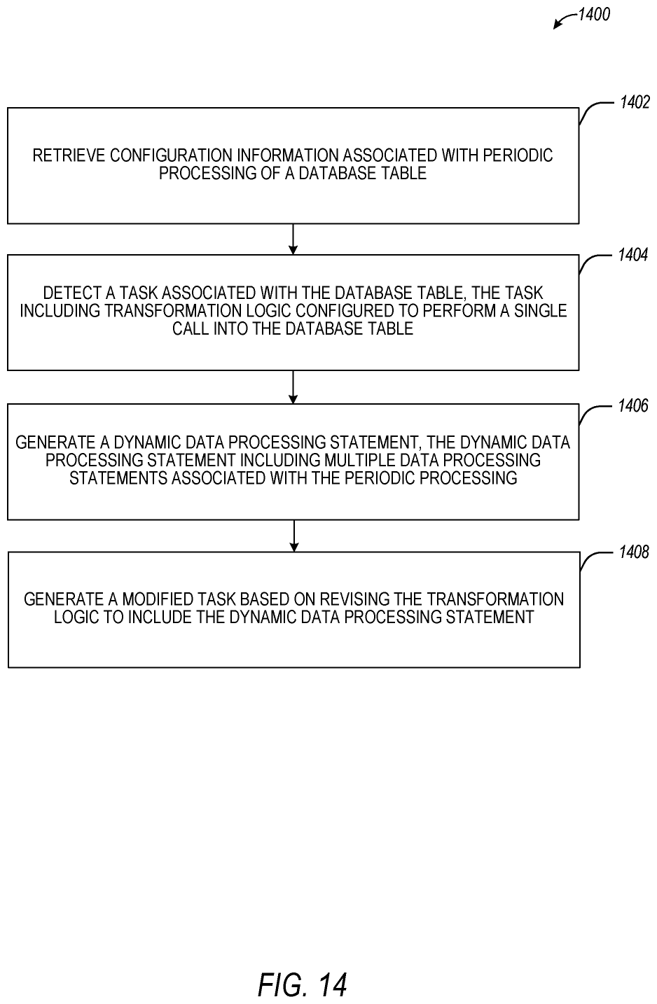

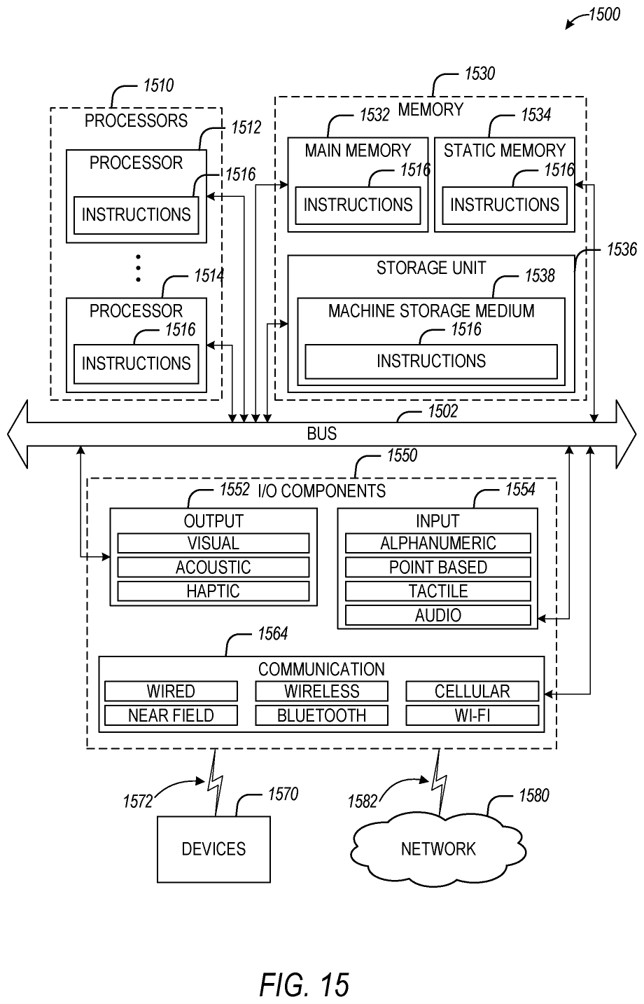

The various embodiments that are described herein are described with reference where appropriate to one or more of the various figures. An example computing environment using a task configuration (TC) manager for configuring tasks based on dynamic data processing statements (e.g., dynamic SQL statements) is discussed in connection with FIGS. 1-3. A more detailed description of the TC manager is provided in connection with FIG. 4. Example data processing pipelines that can be used in connection with the disclosed techniques are discussed in connection with FIG. 5 and FIG. 9. Example stream processing which can be used with the disclosed techniques is discussed in connection with FIGS. 6-8. Example tasks modified based on the disclosed techniques are illustrated in FIGS. 10-13. An example task configuration method is discussed in connection with FIG. 14. A more detailed discussion of example computing devices that may be used in connection with the disclosed techniques is provided in connection with FIG. 15.

FIG. 1 illustrates an example computing environment 100 that includes a database system in the example form of a network-based database system 102, in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein. In other embodiments, the computing environment may comprise another type of network-based database system or a cloud data platform. For example, in some aspects, the computing environment 100 may include a cloud computing platform 101 with the network-based database system 102, and storage platforms 104 (also referred to as cloud storage platforms). The cloud computing platform 101 provides computing resources and storage resources that may be acquired (purchased) or leased (e.g., by data providers and data consumers), and configured to execute applications and store data.

The cloud computing platform 101 may host a cloud computing service 103 that facilitates storage of data on the cloud computing platform 101 (e.g., data management and access) and analysis functions (e.g., SQL queries, analysis), as well as other processing capabilities (e.g., performing identity resolution and data enrichment functions described herein). The cloud computing platform 101 may include a three-tier architecture: data storage (e.g., storage platforms 104 and 122), an execution platform 110 (e.g., providing query processing), and a compute service manager 108 providing cloud services (e.g., dynamic SQL statement functionalities associated with task configuration as performed by the TC manager 130).

It is often the case that organizations that are customers of a given data platform also maintain data storage (e.g., a data lake) that is external to the data platform (i.e., one or more external storage locations). For example, a company could be a customer of a particular data platform and also separately maintain storage of any number of files—be they unstructured files, semi-structured files, structured files, and/or files of one or more other types—on, as examples, one or more of their servers and/or on one or more cloud-storage platforms such as AMAZON WEB SERVICES™ (AWS™), MICROSOFT® AZURE®, GOOGLE CLOUD PLATFORM™, and/or the like. The customer's servers and cloud-storage platforms are both examples of what a given customer could use as what is referred to herein as an external storage location. The cloud computing platform 101 could also use a cloud-storage platform as what is referred to herein as an internal storage location concerning the data platform.

From the perspective of the network-based database system 102 of the cloud computing platform 101, one or more files that are stored at one or more storage locations are referred to herein as being organized into one or more of what is referred to herein as either “internal stages” or “external stages.” Internal stages are stages that correspond to data storage at one or more internal storage locations, and where external stages are stages that correspond to data storage at one or more external storage locations. In this regard, external files can be stored in external stages at one or more external storage locations, and internal files can be stored in internal stages at one or more internal storage locations, which can include servers managed and controlled by the same organization (e.g., company) that manages and controls the data platform, and which can instead or in addition include data-storage resources operated by a storage provider (e.g., a cloud-storage platform) that is used by the data platform for its “internal” storage. The internal storage of a data platform is also referred to herein as the “storage platform” of the data platform. It is further noted that a given external file that a given customer stores at a given external storage location may or may not be stored in an external stage in the external storage location—i.e., in some data-platform implementations, it is a customer's choice whether to create one or more external stages (e.g., one or more external-stage objects) in the customer's data-platform account as an organizational and functional construct for conveniently interacting via the data platform with one or more external files.

As shown, the network-based database system 102 of the cloud computing platform 101 is in communication with the cloud storage platforms 104 and 122 (e.g., AWS®, Microsoft Azure Blob Storage®, or Google Cloud Storage), client device 114 (e.g., a data provider), and data consumer 115 via network 106. The network-based database system 102 is a network-based system used for reporting and analysis of integrated data from one or more disparate sources including one or more storage locations within the cloud storage platform 104. The cloud storage platform 104 comprises a plurality of computing machines and provides on-demand computer system resources such as data storage and computing power to the network-based database system 102.

The network-based database system 102 comprises a compute service manager 108, an execution platform 110, and one or more metadata databases 112. The network-based database system 102 hosts and provides data reporting and analysis services (as well as additional services such as the disclosed identity resolution and data enrichment functions) to multiple client accounts, including an account of the data provider associated with client device 114 and an account of the data consumer 115. In some embodiments, the compute service manager 108 comprises the TC manager 130 which can be used to configure tasks using dynamic data processing statements (e.g., dynamic SQL statements) for extensible, table-driven data manipulations instead of hard-coded data processing procedures. A more detailed description of the task modification functions provided by the TC manager 130 is provided in connection with FIGS. 4-14.

The compute service manager 108 coordinates and manages operations of the network-based database system 102. The compute service manager 108 also performs query optimization and compilation as well as managing clusters of computing services that provide compute resources (also referred to as “virtual warehouses”). The compute service manager 108 can support any number of client accounts such as end-users providing data storage and retrieval requests, accounts of data providers, accounts of data consumers, system administrators managing the systems and methods described herein, and other components/devices that interact with the compute service manager 108.

The compute service manager 108 is also in communication with a client device 114. The client device 114 corresponds to a user of one of the multiple client accounts (e.g., a data provider) supported by the network-based database system 102. The data provider may utilize application connector 128 at the client device 114 to submit data storage, retrieval, and analysis requests to the compute service manager 108 as well as to access or configure other services provided by the compute service manager 108 (e.g., task configuration functions). For example, application connector 128 can be used for communicating task configuration data 132 to the network-based database system 102, which can be used by the TC manager 130 for configuring the task configuration functions.

Client device 114 (also referred to as user device 114) may include one or more of a laptop computer, a desktop computer, a mobile phone (e.g., a smartphone), a tablet computer, a cloud-hosted computer, cloud-hosted serverless processes, or other computing processes or devices may be used to access services provided by the cloud computing platform 101 (e.g., cloud computing service 103) by way of a network 106, such as the Internet or a private network.

In the description below, actions are ascribed to users, particularly consumers and providers. Such actions shall be understood to be performed concerning client device (or devices) 114 operated by such users. For example, a notification to a user may be understood to be a notification transmitted to client device 114, input or instruction from a user may be understood to be received by way of the client device 114, and interaction with an interface by a user shall be understood to be interaction with the interface on the client device 114. In addition, database operations (joining, aggregating, analysis, etc.) ascribed to a user (consumer or provider) shall be understood to include performing such actions by the cloud computing service 103 in response to an instruction from that user.

In some aspects, a data consumer 115 can communicate with the client device 114 to access functions offered by the data provider. Additionally, the data consumer can access functions (e.g., task modification based on dynamic SQL statement functionalities) offered by the network-based database system 102 via the network 106.

The compute service manager 108 is also coupled to one or more metadata databases 112 that store metadata about various functions and aspects associated with the network-based database system 102 and its users. For example, a metadata database 112 may include a summary of data stored in remote data storage systems as well as data available from a local cache. Additionally, a metadata database 112 may include information regarding how data is organized in remote data storage systems (e.g., the cloud storage platform 104) and the local caches. Information stored by a metadata database 112 allows systems and services to determine whether a piece of data needs to be accessed without loading or accessing the actual data from a storage device.

The compute service manager 108 is further coupled to the execution platform 110, which provides multiple computing resources (e.g., execution nodes) that execute, for example, various data storage, data retrieval, and data processing tasks. The execution platform 110 is coupled to storage platform 104 and cloud storage platforms 122. The storage platform 104 comprises multiple data storage devices 120-1 to 120-N. In some embodiments, the data storage devices 120-1 to 120-N are cloud-based storage devices located in one or more geographic locations. For example, the data storage devices 120-1 to 120-N may be part of a public cloud infrastructure or a private cloud infrastructure. The data storage devices 120-1 to 120-N may be hard disk drives (HDDs), solid-state drives (SSDs), storage clusters, Amazon S3™ storage systems, or any other data-storage technology. Additionally, the cloud storage platform 104 may include distributed file systems (such as Hadoop Distributed File Systems (HDFS)), object storage systems, and the like. In some embodiments, at least one internal stage 126 may reside on one or more of the data storage devices 120-1-120-N, and at least one external stage 124 may reside on one or more of the cloud storage platforms 122.

In some embodiments, communication links between elements of the computing environment 100 are implemented via one or more data communication networks, such as network 106. These data communication networks may utilize any communication protocol and any type of communication medium. In some embodiments, the data communication networks are a combination of two or more data communication networks (or sub-Networks) coupled with one another. In alternate embodiments, these communication links are implemented using any type of communication medium and any communication protocol.

The compute service manager 108, metadata database(s) 112, execution platform 110, and storage platform 104, are shown in FIG. 1 as individual discrete components. However, each of the compute service manager 108, metadata database(s) 112, execution platform 110, and storage platforms 104 and 122 may be implemented as a distributed system (e.g., distributed across multiple systems/platforms at multiple geographic locations). Additionally, each of the compute service manager 108, metadata database(s) 112, execution platform 110, and storage platforms 104 and 122 can be scaled up or down (independently of one another) depending on changes to the requests received and the changing needs of the network-based database system 102. Thus, in the described embodiments, the network-based database system 102 is dynamic and supports regular changes to meet the current data processing needs.

During typical operation, the network-based database system 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in a metadata database 112 assists the compute service manager 108 in determining which nodes in the execution platform 110 have already cached at least a portion of the data needed to process the task. One or more nodes in the execution platform 110 process the task using data cached by the nodes and, if necessary, data retrieved from the cloud storage platform 104. It is desirable to retrieve as much data as possible from caches within the execution platform 110 because the retrieval speed is typically much faster than retrieving data from the cloud storage platform 104.

As shown in FIG. 1, the cloud computing platform 101 of the computing environment 100 separates the execution platform 110 from the storage platform 104. In this arrangement, the processing resources and cache resources in the execution platform 110 operate independently of the data storage devices 120-1 to 120-N in the cloud storage platform 104. Thus, the computing resources and cache resources are not restricted to specific data storage devices 120-1 to 120-N. Instead, all computing resources and all cache resources may retrieve data from, and store data to, any of the data storage resources in the cloud storage platform 104.

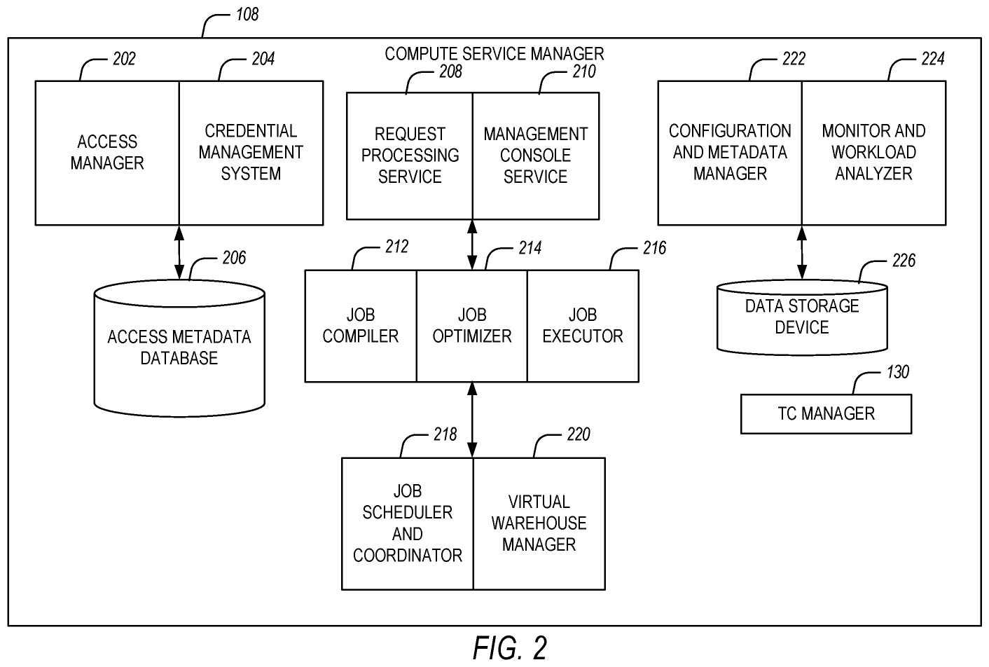

FIG. 2 is a block diagram illustrating components of the compute service manager 108, in accordance with some embodiments of the present disclosure. As shown in FIG. 2, the compute service manager 108 includes an access manager 202 and a credential management system 204 coupled to an access metadata database 206, which is an example of the metadata database(s) 112. Access manager 202 handles authentication and authorization tasks for the systems described herein. The credential management system 204 facilitates the use of remotely stored credentials (e.g., credentials stored in one of the remote credential stores) to access external resources such as data resources in a remote storage device. As used herein, the remote storage devices may also be referred to as “persistent storage devices” or “shared storage devices.” For example, the credential management system 204 may create and maintain remote credential store definitions and credential objects (e.g., in the access metadata database 206). A remote credential store definition identifies a remote credential store (e.g., one or more of the remote credential stores) and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the credential management system 204 and access manager 202 use information stored in the access metadata database 206 (e.g., a credential object and a credential store definition) to retrieve security credentials used to access the external resource from a remote credential store.

A request processing service 208 manages received data storage requests and data retrieval requests (e.g., jobs to be performed on database data). For example, the request processing service 208 may determine the data to process a received query (e.g., a data storage request or data retrieval request). The data may be stored in a cache within the execution platform 110 or in a data storage device in storage platform 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. Job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and then processed in that prioritized order. In an embodiment, the job scheduler and coordinator 218 determines a priority for internal jobs that are scheduled by the compute service manager 108 with other “outside” jobs such as user queries that may be scheduled by other systems in the database but may utilize the same processing resources in the execution platform 110. In some embodiments, the job scheduler and coordinator 218 identifies or assigns particular nodes in the execution platform 110 to process particular tasks. A virtual warehouse manager 220 manages the operation of multiple virtual warehouses implemented in the execution platform 110. For example, the virtual warehouse manager 220 may generate query plans for executing received queries.

Additionally, the compute service manager 108 includes a configuration and metadata manager 222, which manages the information related to the data stored in the remote data storage devices and the local buffers (e.g., the buffers in the execution platform 110). The configuration and metadata manager 222 uses metadata to determine which data files need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the network-based database system 102 and may further redistribute tasks based on a user (e.g., “external”) query workload that may also be processed by the execution platform 110. The configuration and metadata manager 222 and the monitor and workload analyzer 224 are coupled to a data storage device 226. The data storage device 226 in FIG. 2 represents any data storage device within the network-based database system 102. For example, data storage device 226 may represent buffers in execution platform 110, storage devices in storage platform 104, or any other storage device.

As described in embodiments herein, the compute service manager 108 validates all communication from an execution platform (e.g., the execution platform 110) to validate that the content and context of that communication are consistent with the task(s) known to be assigned to the execution platform. For example, an instance of the execution platform executing a query A should not be allowed to request access to data-source D (e.g., data storage device 226) that is not relevant to query A. Similarly, a given execution node (e.g., execution node 302-1 may need to communicate with another execution node (e.g., execution node 302-2), and should be disallowed from communicating with a third execution node (e.g., execution node 312-1) and any such illicit communication can be recorded (e.g., in a log or other location). Also, the information stored on a given execution node is restricted to data relevant to the current query and any other data is unusable, rendered so by destruction or encryption where the key is unavailable.

In some embodiments, the compute service manager 108 further includes the TC manager 130 which can configure and provide task configuration functions to accounts of tenants of the network-based database system 102 (e.g., an account of the data provider associated with client device 114 and an account of the data consumer 115). A more detailed description of the task configuration functions provided by the TC manager 130 is provided in connection with FIGS. 4-14.

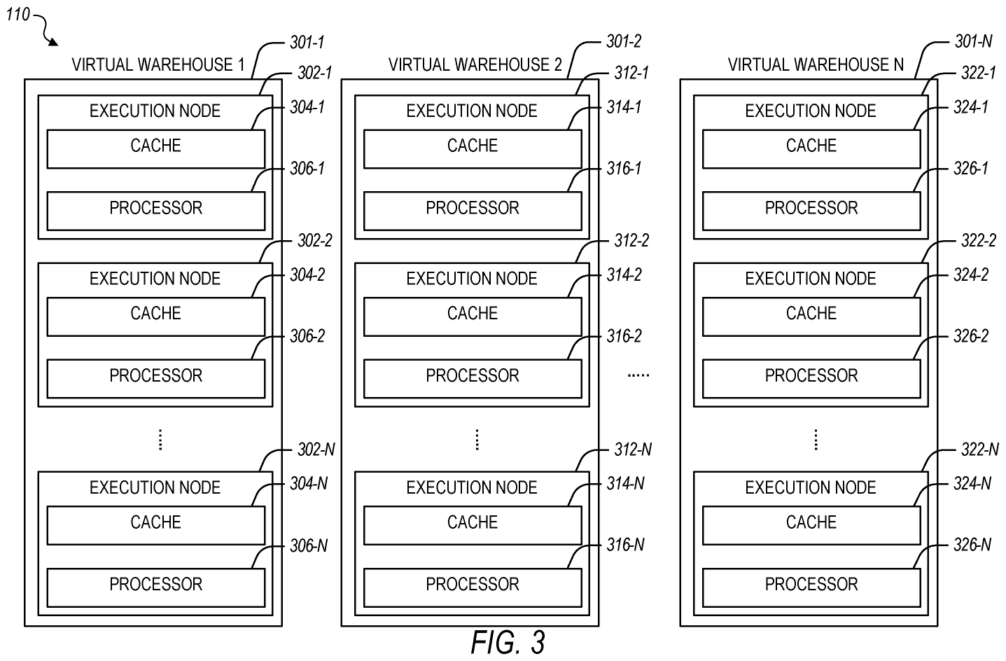

FIG. 3 is a block diagram illustrating components of the execution platform 110, in accordance with some embodiments of the present disclosure. As shown in FIG. 3, the execution platform 110 includes multiple virtual warehouses, including virtual warehouse 1 (or 301-1), virtual warehouse 2 (or 301-2), and virtual warehouse N (or 301-N). Each virtual warehouse includes multiple execution nodes that each include a data cache and a processor. The virtual warehouses can execute multiple tasks in parallel by using multiple execution nodes. As discussed herein, the execution platform 110 can add new virtual warehouses and drop existing virtual warehouses in real-time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in the cloud storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing any of the data storage devices 120-1 to 120-N shown in FIG. 1. Thus, the virtual warehouses are not necessarily assigned to a specific data storage device 120-1 to 120-N and, instead, can access data from any of the data storage devices 120-1 to 120-N within the cloud storage platform 104. Similarly, each of the execution nodes shown in FIG. 3 can access data from any of the data storage devices 120-1 to 120-N. In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data being cached by the execution nodes. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although each of the execution nodes shown in FIG. 3 includes one data cache and one processor, alternative embodiments may include execution nodes containing any number of processors and any number of caches. Additionally, the caches may vary in size among the different execution nodes. The caches illustrated in FIG. 3 store, in the local execution node, data that was retrieved from one or more data storage devices in the cloud storage platform 104. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity.

Although virtual warehouses 1, 2, and N are associated with the same execution platform 110, virtual warehouses 1, N may be implemented using multiple computing systems at multiple geographic locations. For example, virtual warehouse 1 can be implemented by a computing system at a first geographic location, while virtual warehouses 2 and n are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location, and execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault-tolerant. For example, if one virtual warehouse fails, that virtual warehouse is quickly replaced with a different virtual warehouse at a different geographic location.

A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in the cloud storage platform 104, but each virtual warehouse has its execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

FIGS. 4-14 describe aspects of using dynamic data processing statements (e.g., dynamic SQL statements) in connection with task configuration performed by the TC manager 130.

FIG. 4 is a block diagram 400 of a TC manager in communication with an execution platform, in accordance with some embodiments of the present disclosure. Referring to FIG. 4, the TC manager 130 includes a task input configuration manager 410, a task output configuration manager 412, a periodicity configuration manager 414, a dynamic statement generator 416, and a task execution manager 408.

In operation, the TC manager 130 performs processing functions 406 to generate a modified task 424 (also referred to as a dynamic execution task) using one or more of the task input configuration manager 410, the task output configuration manager 412, the periodicity configuration manager 414, and the dynamic statement generator 416.

In operation, the TC manager 130 receives a job 402 that may be divided into one or more tasks 404, e.g., task 0, task 1, task 2, task 3, and so forth through task N. The TC manager 130 receives the job at operation 418 and determines one or more tasks at operation 420 that may be carried out to execute the job 402. The TC manager 130 is configured to determine the one or more tasks 404 based on applicable rules and/or parameters. The TC manager 130 modifies at least one of the tasks 404 at operation 422, using one or more of the task input configuration manager 410, the task output configuration manager 412, the periodicity configuration manager 414, and the dynamic statement generator 416. The modified task 424 can be executed by task execution manager 408 using computing resources of the execution platform 110. In some embodiments, the task transformation logic of the task is modified by including a dynamic data processing statement (e.g., dynamic SQL statement) 434 and generating the modified task 424.

The task input configuration manager 410 comprises suitable circuitry, logic, interfaces, and/or code and configures input data for the modified task 424. For example, the task input configuration manager 410 is used to configure input data location which can be stored as other configuration information 432 of the modified task 424. Other configurations include designating computing resources for execution of the task (e.g., virtual warehouse information 430 designating computing resources of at least one virtual warehouse of the execution platform 110).

The task output configuration manager 412 comprises suitable circuitry, logic, interfaces, and/or code and configures the output of the modified task 424. For example, output configurations can include output data format, output storage location, and configurations for one or more post-processing functions (e.g., result storage or analysis functions). The output configurations can be stored as other configuration information 432 of the modified task 424.

The dynamic statement generator 416 comprises suitable circuitry, logic, interfaces, and/or code and configures a dynamic data processing statement 434 which can be used as part of the transformation logic of the modified task 424. In some aspects, the dynamic data processing statement 434 is a dynamic SQL statement, which can include multiple other SQL statements. In some aspects, the dynamic SQL statement can be used for table-driven execution of data manipulations (e.g., as discussed in connection with FIG. 12). In this regard, the dynamic SQL statement can be used for performing multiple data processing calls on data objects that change over time.

The periodicity configuration manager 414 comprises suitable circuitry, logic, interfaces, and/or code and configures one or both of schedule information 426 and periodicity information 428 for the modified task 424. Periodicity information 428 can indicate periodicity for performing a data processing operation associated with the dynamic SQL statement. The schedule information 426 can indicate a pre-configured schedule for performing the data processing operation associated with the dynamic SQL statement.

In some embodiments, the operation of the task input configuration manager 410, the task output configuration manager 412, the periodicity configuration manager 414, and the dynamic statement generator 416 can be configured based on the TC data 132 received via the client device 114.

FIG. 5 is a block diagram of a data processing pipeline, in accordance with some embodiments of the present disclosure. Referring to FIG. 5, data processing operations 502 are applied to database table 504 in the data processing pipeline 500. The scheduling and orchestration function 506 can be used for the configuration of change data capture (CDC) processing 508 and transformation logic 510. In some embodiment, CDC processing can be performed using a stream object (also referred to as a stream). Example stream object processing which can be used in the data processing pipeline 500 is discussed in connection with FIGS. 6-8.

In an example embodiment, transformation logic 510 can be associated with at least one data processing operation and can be part of a task. In some embodiments, the TC manager 130 can be used to modify such a task using the disclosed techniques (e.g., by including at least one dynamic SQL statement as part of the transformation logic 510). An example task modification using such a dynamic SQL statement is discussed in connection with FIG. 9.

The data processing pipeline 500 can store result data (e.g., data generated after the task with the transformation logic 510 is completed) in database table 512. Additionally, the data processing pipeline 500 can include post-processing 514 (e.g., data analysis) performed on the result data stored in database table 512.

FIG. 6 is diagram 600 of a stream object configuration for a table, in accordance with some embodiments of the present disclosure. Referring to FIG. 6, queries or data processing commands Insert 604, Delete 606, and Update 608 are applied to source table 602. As illustrated in FIG. 6, a stream 614 is generated on source table T1 602 at times X1, X2 (after a time interval of 610 from X1), and X3 (after a time interval of 612 from X2). Additionally, at operation 616, table T2 can be created on stream S1. At operation 618, a stream entry from stream S1 at time X1 is inserted into table T2. At operation 620, a stream entry from stream S1 at time X2 is inserted into table T2. In this regard, stream data on source table 602 can be isolated and stored in a separate table T2 for additional processing.

As used herein, the term “access control” indicates that customers can control who can access database objects within their organization. As used herein, the term “data sharing” indicates customers (e.g., data consumers or data providers) can grant access to database objects (e.g., a database table or a view in connection with identity resolution and data enrichment techniques disclosed herein) to other organizations (e.g., other data providers or other data consumers). In some aspects, any query with a CHANGES clause or a stream may be referred to as a change query. A change query on a view may be defined similarly.

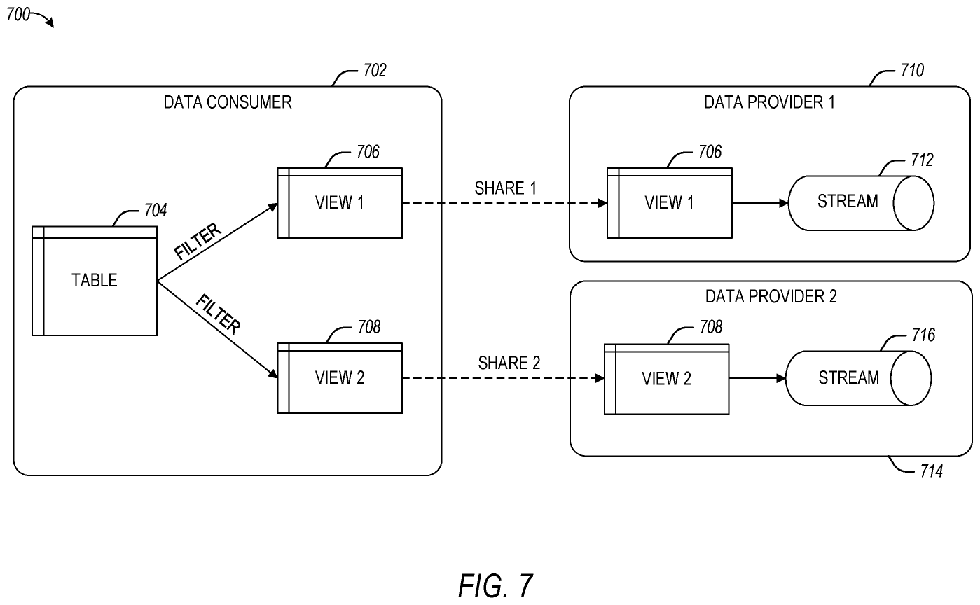

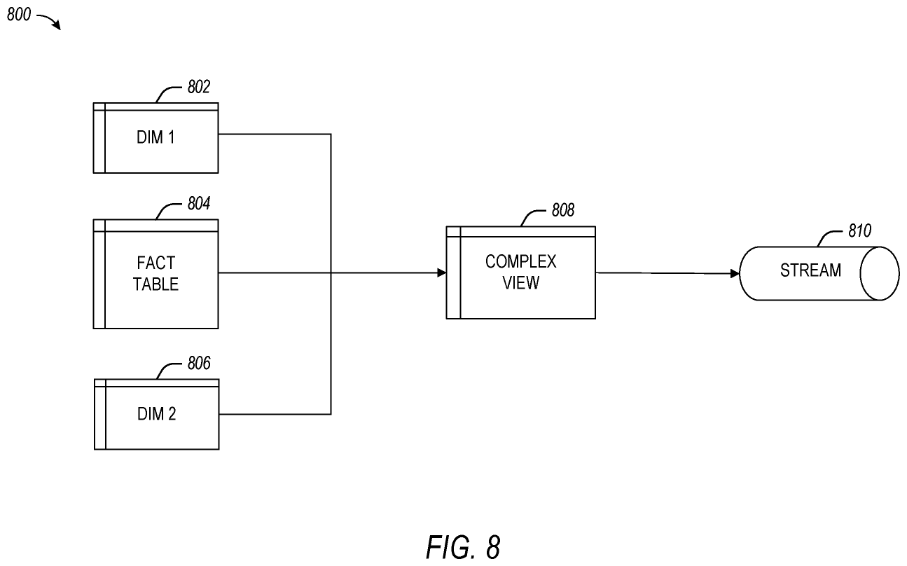

In some embodiments, the TC manager 130 is configured to provide changes to views (e.g., a stream on views) so that the changes may be further processed and acted on. More specifically, the TC manager 130 may be configured to provide or process streams on views in connection with different use cases, such as shared views (e.g., as discussed in connection with FIG. 7) and complex views (e.g., as discussed in connection with FIG. 8). In some aspects, more than one use case may apply at a given time.

Shared (secure) views may be used to provide (e.g., a user or organization) limited access to sensitive data. The consumer of the data often wishes to observe changes to the data being shared with them. Some considerations implied by this use case include giving the consumer visibility into the shared view's retention period and how to enforce secure view limitations on change queries.

FIG. 7 is a diagram 700 of shared views, in accordance with some embodiments of the present disclosure. Referring to FIG. 7, a data consumer 702 manages a source table 704. The data consumer 702 can apply different filters to source table 704 to generate views 706 and 708. For example, data consumer 702 can apply different filters to source table 704 so that different views from the table are shared with different data providers (e.g., data providers 710 and 714). In this regard, view 706 is shared with data provider 710, and view 708 is shared with data provider 714. In some embodiments, streams 712 and 716 are configured on corresponding views 706 and 708 for consumption by data providers 710 and 714 (e.g., in connection with task modification of a task performed on streams 712 and 716).

The definition of a view can be complex but observing the changes to such a view may be useful independently of its complexity. Manually constructing a query to compute those changes may be achieved, but can be toilsome, error-prone, and suffer from performance issues. In some aspects, a change query on a view may automatically rewrite the view query, relieving users of this burden. In some aspects, simple views containing only row-wise operators (e.g., select, project, union all) may be used. In some aspects, complex views that join fact tables with (potentially several) slowly-changing-dimension (DIM) tables may also be used. Other kinds of operators like aggregates, windowing functions, and recursion may also be used in connection with complex views.

FIG. 8 is a diagram 800 of a stream object based on a complex view, in accordance with some embodiments of the present disclosure. Referring to FIG. 8, a complex view 808 may be generated based on source tables 802, 804, and 806. In some aspects, a stream 810 (e.g., at an account of a data provider) is configured based on the complex view 808 of source tables 802, 804, and 806. A modified task (e.g., a task using a dynamic SQL statement) can be executed on data obtained via stream 810.

FIG. 9 is a block diagram of a data processing pipeline using a modified task with a dynamic SQL statement, in accordance with some embodiments of the present disclosure. The processing pipeline of FIG. 9 is similar to the data processing pipeline in FIG. 5, except that FIG. 9 provides additional detail regarding task modification using a dynamic SQL statement. Referring to FIG. 9, data processing operations 902 are applied to database table 904 in the data processing pipeline 900. Change data capture (CDC) processing can be performed on the database table 904 using a table stream 906 to generate stream data. The stream data can be processed further using task 908 with transformation logic 910.

In an example embodiment, transformation logic 910 is associated with at least one data processing operation 918. In some embodiments, the TC manager 130 can be used to modify task 908 by including at least one dynamic SQL statement 912 as part of the transformation logic 910. Example dynamic SQL statements which can be used for task modification of task 908 are illustrated in FIGS. 10-13.

The data processing pipeline 900 can store result data (e.g., data generated after task 908 is modified with the dynamic SQL statement 912 and is completed) in database table 914. Additionally, the data processing pipeline 900 can include post-processing 916 (e.g., data analysis) performed on the result data stored in database table 914. In some embodiments, the dynamic SQL statement can further configure at least one data processing call for storing the result data in database table 914 and performing the post-processing 916.

In some embodiments, the disclosed techniques associated with dynamic data processing statements (e.g., dynamic SQL statements) can be used for performing tasks on data objects that change over time (e.g., to perform schema-level processing of changing data objects). Some advantages of the disclosed techniques over techniques using task-specific, hard-coded procedures include the following: (a) no JavaScript coding is required; (b) previous solutions would require a more complex process, such as creating custom stored procedures with 3rd party workflows, debugging and deploying executable code to an external cloud storage or file directory, then externally scheduling the running of these processes to the appropriate account that is located in the other cloud provider/cloud region; (c) can be used to achieve efficient software development life cycle (SDLC) processing (e.g., logic changes entail updating data in extract-load-transform (ELT) process scripting tables and views); (d) no third party services are needed for extract-transform-load (ETL) processing and scheduling; and (e) with dynamic SQL functionality, tasks can be modified to create monthly backup clone databases for auditing (e.g., as illustrated in FIG. 10), role time-boxing (e.g., in connection with access grants for production data issue fixes and time-boxing users for limited regulatory audit access, as illustrated in FIG. 11), run table-driven ELT routines for ingestion, transformation, and presentation (e.g., as illustrated in FIG. 12).

FIG. 10, FIG. 11, FIG. 12, and FIG. 13 illustrate example modified tasks including transformation logic with dynamic SQL statements, in accordance with some embodiments of the present disclosure.

FIG. 10 illustrates a task 1000 for creating a monthly clone (or snapshot) database. More specifically, task 1000 has been modified to include configuration information 1002 such as scheduling information, original/source database identification, and other configuration information. Task 1000 is also modified to include a dynamic SQL statement 1004 to trigger the generation of the monthly clone database at the schedule indicated by the configuration information 1002.

FIG. 11 illustrates a task 1100 for performing role time-boxing (e.g., in connection with access grants for production data issue fixes and time-boxing users for limited regulatory audit access). For example, task 1100 has been modified to include configuration information 1102, such as scheduling information, original/source database identification, and other configuration information. Task 1100 is also modified to include dynamic SQL statement 1104 to trigger the time-boxing at the desired schedule (e.g., trigger revocation of certain user roles that have been created since a specified date). In some aspects, the dynamic SQL statement 1104 can be used for interrogating multiple database tables, checking the table metadata for privilege information, and revoking the user roles/privileges which satisfy the revocation condition.

FIG. 12 illustrates a table-driven script runner 1200, which includes a script statement 1202. The script statement 1202 includes multiple ELT scripts, which can be used for specifying multiple data processing tasks (associated with multiple data processing calls) of a data processing pipeline. In some embodiment, the TC manager 130 can modify a task to include the table-driven script runner 1200 with a table-based script statement 1202. In this regard, if any of the data manipulations change over time, one or more of the ELT scripts in the script statement 1202 can be modified instead of modifying hard-coded solutions/procedures for performing the data manipulations.

In some embodiments, an example script statement 1202 can include ELT scripts for performing the following functions serially: ELT script 1 can be used for retrieving data from an external stage; ELT script 2 can be used to modify/cleanse the data based on a pre-defined standard; ELT script 3 can be used to integrate and merge the cleansed data with a data warehouse; ELT script 4 can be used to create bins and primitive facts for data consumption; and ELT script 5 can be used to create a dashboard for the data consumption.

In some aspects, data that is being processed during the execution of a dynamic SQL statement can be stored in a staging table. In some embodiments, modified tasks (e.g., tasks that include dynamic SQL statements) can be executed as serverless functions (e.g., using computing resources of the execution platform 110).

FIG. 13 illustrates a table processing task 1300. More specifically, task 1300 has been modified to include dynamic SQL statement 1302, which can be used to identify one or more tables in a schema or a database and perform an indicated data processing function (or functions) on the identified one or more tables at a pre-defined schedule (e.g., based on the task configuration information).

FIG. 14 is a flow diagram illustrating operations of a database system in performing a method 1400 for task configuration, in accordance with some embodiments of the present disclosure. Method 1400 may be embodied in computer-readable instructions for execution by one or more hardware components (e.g., one or more processors) such that the operations of method 1400 may be performed by components of the network-based database system 102, such as components of the compute service manager 108 (e.g., the TC manager 130) and/or the execution platform 110 (e.g., which components may be implemented as machine 1500 of FIG. 15). Accordingly, method 1400 is described below, by way of example with reference thereto. However, it shall be appreciated that method 1400 may be deployed on various other hardware configurations and is not intended to be limited to deployment within the network-based database system 102.

At operation 1402, configuration information associated with periodic processing of a database table is retrieved. For example, the TC manager 130 can retrieve configuration information from the configuration and metadata manager 222 of the compute service manager 108. In some embodiments, the TC manager 130 can also retrieve configuration information associated with dynamic SQL statement functionalities using the TC data 132 communicated from client device 114 via network 106.

At operation 1404, a task associated with the database table is retrieved. For example, about FIG. 9, task 908 can be retrieved by the TC manager 130. Task 908 is associated with the processing of stream data of table stream 906 generated from a source table (e.g., database table 904). Task 908 also includes transformation logic 910 configured to perform a single data processing call (e.g., the data processing operation 918) into the database table.

At operation 1406, a dynamic data processing statement is generated. For example, the TC manager 130 generates a dynamic SQL statement 912, which can include multiple data processing statements associated with the periodic processing. Example dynamic SQL statements are discussed in connection with FIGS. 10-13.

At operation 1408, a modified task is generated based on revising the transformation logic to include the dynamic data processing statement. For example, the TC manager 130 can revise the transformation logic 910 to include the dynamic SQL statement 912 and modify task 908.

FIG. 15 illustrates a diagrammatic representation of a machine 1500 in the form of a computer system within which a set of instructions may be executed for causing the machine 1500 to perform any one or more of the methodologies discussed herein, according to an example embodiment. Specifically, FIG. 15 shows a diagrammatic representation of the machine 1500 in the example form of a computer system, within which instructions 1516 (e.g., software, a program, an application, an applet, an app, or other executable code) for causing the machine 1500 to perform any one or more of the methodologies discussed herein may be executed. For example, instructions 1516 may cause machine 1500 to execute any one or more operations of method 1400 (or any other technique discussed herein, for example in connection with FIG. 4-FIG. 14). As another example, instructions 1516 may cause machine 1500 to implement one or more portions of the functionalities discussed herein. In this way, instructions 1516 may transform a general, non-programmed machine into a particular machine 1500 (e.g., the compute service manager 108 or a node in the execution platform 110) that is specially configured to carry out any one of the described and illustrated functions in the manner described herein. In yet another embodiment, instructions 1516 may configure the compute service manager 108 and/or a node in the execution platform 110 to carry out any one of the described and illustrated functions in the manner described herein.

In alternative embodiments, the machine 1500 operates as a standalone device or may be coupled (e.g., networked) to other machines. In a networked deployment, the machine 1500 may operate in the capacity of a server machine or a client machine in a server-client network environment, or as a peer machine in a peer-to-peer (or distributed) network environment. The machine 1500 may comprise, but not be limited to, a server computer, a client computer, a personal computer (PC), a tablet computer, a laptop computer, a netbook, a smartphone, a mobile device, a network router, a network switch, a network bridge, or any machine capable of executing the instructions 1516, sequentially or otherwise, that specify actions to be taken by the machine 1500. Further, while only a single machine 1500 is illustrated, the term “machine” shall also be taken to include a collection of machines 1500 that individually or jointly execute the instructions 1516 to perform any one or more of the methodologies discussed herein.

Machine 1500 includes processors 1510, memory 1530, and input/output (I/O) components 1550 configured to communicate with each other such as via a bus 1502. In some example embodiments, the processors 1510 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1512 and a processor 1514 that may execute the instructions 1516. The term “processor” is intended to include multi-core processors 1510 that may comprise two or more independent processors (sometimes referred to as “cores”) that may execute instructions 1516 contemporaneously. Although FIG. 15 shows multiple processors 1510, the machine 1500 may include a single processor with a single core, a single processor with multiple cores (e.g., a multi-core processor), multiple processors with a single core, multiple processors with multiple cores, or any combination thereof.

The memory 1530 may include a main memory 1532, a static memory 1534, and a storage unit 1536, all accessible to the processors 1510 such as via the bus 1502. The main memory 1532, the static memory 1534, and the storage unit 1536 store the instructions 1516 embodying any one or more of the methodologies or functions described herein. The instructions 1516 may also reside, completely or partially, within the main memory 1532, within the static memory 1534, within machine storage medium 1538 of the storage unit 1536, within at least one of the processors 1510 (e.g., within the processor's cache memory), or any suitable combination thereof, during execution thereof by the machine 1500.

The I/O components 1550 include components to receive input, provide output, produce output, transmit information, exchange information, capture measurements, and so on. The specific I/O components 1550 that are included in a particular machine 1500 will depend on the type of machine. For example, portable machines such as mobile phones will likely include a touch input device or other such input mechanisms, while a headless server machine will likely not include such a touch input device. It will be appreciated that the I/O components 1550 may include many other components that are not shown in FIG. 15. The I/O components 1550 are grouped according to functionality merely for simplifying the following discussion and the grouping is in no way limiting. In various example embodiments, the I/O components 1550 may include output components 1552 and input components 1554. The output components 1552 may include visual components (e.g., a display such as a plasma display panel (PDP), a light-emitting diode (LED) display, a liquid crystal display (LCD), a projector, or a cathode ray tube (CRT)), acoustic components (e.g., speakers), other signal generators, and so forth. The input components 1554 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touches gestures or other tactile input components), audio input components (e.g., a microphone), and the like.

Communication may be implemented using a wide variety of technologies. The I/O components 1550 may include communication components 1564 operable to couple the machine 1500 to a network 1580 or devices 1570 via a coupling 1582 and a coupling 1572, respectively. For example, the communication components 1564 may include a network interface component or another suitable device to interface with the network 1580. In further examples, the communication components 1564 may include wired communication components, wireless communication components, cellular communication components, and other communication components to provide communication via other modalities. The device 1570 may be another machine or any of a wide variety of peripheral devices (e.g., a peripheral device coupled via a universal serial bus (USB)). For example, as noted above, machine 1500 may correspond to any one of the compute service manager 108 or the execution platform 110, and the device 1570 may include the client device 114 or any other computing device described herein as being in communication with the network-based database system 102, the storage platform 104, or the cloud storage platforms 122.

The various memories (e.g., 1530, 1532, 1534, and/or memory of the processor(s) 1510 and/or the storage unit 1536) may store one or more sets of instructions 1516 and data structures (e.g., software) embodying or utilized by any one or more of the methodologies or functions described herein. These instructions 1516, when executed by the processor(s) 1510, cause various operations to implement the disclosed embodiments.

As used herein, the terms “machine-storage medium,” “device-storage medium,” and “computer-storage medium” mean the same thing and may be used interchangeably in this disclosure. The terms refer to single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1580 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1580 or a portion of the network 1580 may include a wireless or cellular network, and the coupling 1582 may be a Code Division Multiple Access (CDMA) connection, a Global System for Mobile communications (GSM) connection, or another type of cellular or wireless coupling. In this example, the coupling 1582 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 1516 may be transmitted or received over the network 1580 using a transmission medium via a network interface device (e.g., a network interface component included in the communication components 1564) and utilizing any one of several well-known transfer protocols (e.g., hypertext transfer protocol (HTTP)). Similarly, instructions 1516 may be transmitted or received using a transmission medium via the coupling 1572 (e.g., a peer-to-peer coupling) to the device 1570. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1516 for execution by the machine 1500, and include digital or analog communications signals or other intangible media to facilitate communication of such software. Hence, the terms “transmission medium” and “signal medium” shall be taken to include any form of a modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the disclosed methods may be performed by one or more processors. The performance of some of the operations may be distributed among the one or more processors, not only residing within a single machine but also deployed across several machines. In some example embodiments, the processor or processors may be located in a single location (e.g., within a home environment, an office environment, or a server farm), while in other embodiments the processors may be distributed across several locations.

Described implementations of the subject matter can include one or more features, alone or in combination as illustrated below by way of examples.

Example 1 is a system comprising: at least one hardware processor; and at least one memory storing instructions that cause the at least one hardware processor to perform operations comprising: retrieving configuration information associated with periodic processing of a database table; detecting a task associated with the database table, the task including transformation logic configured to perform a single call into the database table; generating a dynamic data processing statement, the dynamic data processing statement including multiple data processing statements associated with the periodic processing; and generating a modified task based on revising the transformation logic to include the dynamic data processing statement.

In Example 2, the subject matter of Example 1 includes subject matter where the instructions further cause the at least one hardware processor to perform operations comprising: executing the multiple data processing statements during execution of the modified task.

In Example 3, the subject matter of Example 2 includes subject matter where the configuration information comprises scheduling information associated with a pre-configured schedule, and the instructions further cause the at least one hardware processor to perform operations comprising: executing the multiple data processing statements periodically, at the pre-configured schedule.

In Example 4, the subject matter of Examples 2-3 includes subject matter where the configuration information comprises virtual warehouse information indicating a computing resource, and the instructions further cause the at least one hardware processor to perform operations comprising: executing the multiple data processing statements using the computing resource.

In Example 5, the subject matter of Examples 1˜4 includes subject matter where the instructions further cause the at least one hardware processor to perform operations comprising: executing the modified task as a serverless function using a computing resource indicated by the configuration information.

In Example 6, the subject matter of Example 5 includes subject matter where the instructions further cause the at least one hardware processor to perform operations comprising: determining a duration for executing the modified task as the serverless function and determining accounting information for a user of the modified task based on the duration.

In Example 7, the subject matter of Examples 1-6 includes subject matter where the instructions further cause the at least one hardware processor to perform operations comprising: generating a table-based script statement, the table-based script statement comprising a table with a plurality of extract-load-transform (ELT) scripts.

In Example 8, the subject matter of Example 7 includes subject matter where the instructions further cause the at least one hardware processor to perform operations comprising: configuring the dynamic data processing statement to include a call to one or more ELT scripts of the plurality of ELT scripts.

In Example 9, the subject matter of Example 8 includes subject matter where the instructions further cause the at least one hardware processor to perform operations comprising: executing the modified task based on performing a plurality of data processing operations associated with a data processing pipeline, the plurality of data processing operations configured by the one or more ELT scripts.

In Example 10, the subject matter of Examples 1-9 includes subject matter where the dynamic data processing statement is a dynamic structured query language (SQL) statement, the dynamic SQL statement includes at least one SQL statement associated with a post-processing task, and the instructions further cause the at least one hardware processor to perform operations comprising: executing the at least one SQL statement to perform the post-processing task.

Example 11 is a method comprising: performing by at least one hardware processor operations comprising: retrieving configuration information associated with periodic processing of a database table; detecting a task associated with the database table, the task including transformation logic configured to perform a single call into the database table; generating a dynamic data processing statement, the dynamic data processing statement including multiple data processing statements associated with the periodic processing; and generating a modified task based on revising the transformation logic to include the dynamic data processing statement.

In Example 12, the subject matter of Example 11 includes, executing the multiple data processing statements during the execution of the modified task.

In Example 13, the subject matter of Example 12 includes subject matter where the configuration information comprises scheduling information associated with a pre-configured schedule, and the method further comprises: executing the multiple data processing statements periodically, at the pre-configured schedule.

In Example 14, the subject matter of Examples 12-13 includes subject matter where the configuration information comprises virtual warehouse information indicating a computing resource, and the method further comprises: executing the multiple data processing statements using the computing resource.

In Example 15, the subject matter of Examples 11-14 includes, executing the modified task as a serverless function using a computing resource indicated by the configuration information.

In Example 16, the subject matter of Example 15 includes, determining a duration for executing the modified task as the serverless function; and determining accounting information for a user of the modified task based on the duration.

In Example 17, the subject matter of Examples 11-16 includes, generating a table-based script statement, the table-based script statement comprising a table with a plurality of extract-load-transform (ELT) scripts.

In Example 18, the subject matter of Example 17 includes, configuring the dynamic data processing statement to include a call to one or more ELT scripts of the plurality of ELT scripts.

In Example 19, the subject matter of Example 18 includes, executing the modified task based on performing a plurality of data processing operations associated with a data processing pipeline, the plurality of data processing operations configured by the one or more ELT scripts.

In Example 20, the subject matter of Examples 11-19 includes subject matter where the dynamic data processing statement is a dynamic structured query language (SQL) statement, the dynamic SQL statement includes at least one SQL statement associated with a post-processing task, and the method further comprising: executing the at least one SQL statement to perform the post-processing task.

Example 21 is a computer-storage medium comprising instructions that, when executed by one or more processors of a machine, configure the machine to perform operations comprising: retrieving configuration information associated with periodic processing of a database table; detecting a task associated with the database table, the task including transformation logic configured to perform a single call into the database table; generating a dynamic data processing statement, the dynamic data processing statement including multiple data processing statements associated with the periodic processing; and generating a modified task based on revising the transformation logic to include the dynamic data processing statement.

In Example 22, the subject matter of Example 21 includes, the operations further comprising: executing the multiple data processing statements during execution of the modified task.

In Example 23, the subject matter of Example 22 includes subject matter where the configuration information comprises scheduling information associated with a pre-configured schedule, and the operations further comprise: executing the multiple data processing statements periodically, at the pre-configured schedule.

In Example 24, the subject matter of Examples 22-23 includes subject matter where the configuration information comprises virtual warehouse information indicating a computing resource, and the operations further comprise: executing the multiple data processing statements using the computing resource.

In Example 25, the subject matter of Examples 21-24 includes, the operations further comprising: executing the modified task as a serverless function using a computing resource indicated by the configuration information.

In Example 26, the subject matter of Example 25 includes, the operations further comprising: determining a duration for executing the modified task as the serverless function and determining accounting information for a user of the modified task based on the duration.

In Example 27, the subject matter of Examples 21-26 includes, the operations further comprising: generating a table-based script statement, the table-based script statement comprising a table with a plurality of extract-load-transform (ELT) scripts.

In Example 28, the subject matter of Example 27 includes, the operations further comprising: configuring the dynamic data processing statement to include a call to one or more ELT scripts of the plurality of ELT scripts.

In Example 29, the subject matter of Example 28 includes, the operations further comprising: executing the modified task based on performing a plurality of data processing operations associated with a data processing pipeline, the plurality of data processing operations configured by the one or more ELT scripts.

In Example 30, the subject matter of Examples 21-29 includes subject matter where the dynamic data processing statement is a dynamic structured query language (SQL) statement, the dynamic SQL statement includes at least one SQL statement associated with a post-processing task, and the operations further comprising: executing the at least one SQL statement to perform the post-processing task.

Example 31 is at least one machine-readable medium including instructions that, when executed by processing circuitry, cause the processing circuitry to perform operations to implement any of Examples 1-30.

Example 32 is an apparatus comprising means to implement any of Examples 1-30.

Example 33 is a system to implement any of Examples 1-30.

Example 34 is a method to implement any of Examples 1-30.

Although the embodiments of the present disclosure have been described concerning specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is disclosed. Thus, although specific embodiments have been illustrated and described herein, it should be appreciated that any arrangement calculated to achieve the same purpose may be substituted for the specific embodiments shown. This disclosure is intended to cover any adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

1. A system comprising:
at least one hardware processor; and
at least one memory storing instructions that cause the at least one hardware processor to perform operations comprising:
retrieving configuration information associated with periodic processing of a database table;
detecting a task associated with the database table, the task specifying at least one data processing operation to transform data stored in the database table and metadata of the at least one data processing operation, the metadata specifying at least a period for the periodic processing, and the at least one data processing operation configured to perform a single call into the database table based on the metadata;
generating a dynamic data processing statement, the dynamic data processing statement including multiple data processing statements associated with the periodic processing of the database table; and
revising a portion of the task to generate a modified task, the revising including replacing the at least one data processing operation with the dynamic data processing statement, the modified task further including the configuration information associated with the periodic processing and the metadata indicating at least the period for the periodic processing.

2. The system of claim 1, wherein the instructions further cause the at least one hardware processor to perform operations comprising:
executing the multiple data processing statements during execution of the modified task.

3. The system of claim 2, wherein the configuration information within the modified task comprises scheduling information associated with a pre-configured schedule, and the instructions further cause the at least one hardware processor to perform operations comprising:
executing the multiple data processing statements periodically, at the pre-configured schedule.

4. The system of claim 2, wherein the configuration information within the modified task comprises virtual warehouse information indicating a computing resource available prior to the generating of the modified task, and the instructions further cause the at least one hardware processor to perform operations comprising:
executing the multiple data processing statements using the computing resource.

5. The system of claim 1, wherein the instructions further cause the at least one hardware processor to perform operations comprising:
executing the modified task as a serverless function using a computing resource indicated by the configuration information.

6. The system of claim 5, wherein the instructions further cause the at least one hardware processor to perform operations comprising:
determining a duration for executing the modified task as the serverless function; and
determining accounting information for a user of the modified task based on the duration.

7. The system of claim 1, wherein the instructions further cause the at least one hardware processor to perform operations comprising:
generating a table-based script statement, the table-based script statement comprising a table with a plurality of extract-load-transform (ELT) scripts.

8. The system of claim 7, wherein the instructions further cause the at least one hardware processor to perform operations comprising:
configuring the dynamic data processing statement to include a call to one or more ELT scripts of the plurality of ELT scripts.

9. The system of claim 8, wherein the instructions further cause the at least one hardware processor to perform operations comprising:
executing the modified task based on performing a plurality of data processing operations associated with a data processing pipeline, the plurality of data processing operations configured by the one or more ELT scripts.

10. The system of claim 1, wherein the dynamic data processing statement is a dynamic structured query language (SQL) statement, the dynamic SQL statement including at least one SQL statement associated with a post-processing task, and the instructions further cause the at least one hardware processor to perform operations comprising:
executing the at least one SQL statement to perform the post-processing task.

11. A method comprising:
performing by at least one hardware processor operations comprising:
retrieving configuration information associated with periodic processing of a database table;
detecting a task associated with the database table, the task specifying at least one data processing operation to transform data stored in the database table and metadata of the at least one data processing operation, the metadata specifying at least a period for the periodic processing, and the at least one data processing operation configured to perform a single call into the database table based on the metadata;
generating a dynamic data processing statement, the dynamic data processing statement including multiple data processing statements associated with the periodic processing of the database table; and
revising a portion of the task to generate a modified task, the revising including replacing the at least one data processing operation with the dynamic data processing statement, the modified task further including the configuration information associated with the periodic processing and the metadata indicating at least the period for the periodic processing.

12. The method of claim 11, further comprising:
executing the multiple data processing statements during execution of the modified task.

13. The method of claim 12, wherein the configuration information within the modified task comprises scheduling information associated with a pre-configured schedule, and the method further comprising:
executing the multiple data processing statements periodically, at the pre-configured schedule.

14. The method of claim 12, wherein the configuration information within the modified task comprises virtual warehouse information indicating a computing resource available prior to the generating of the modified task, and the method further comprising:
executing the multiple data processing statements using the computing resource.

15. The method of claim 11, further comprising:
executing the modified task as a serverless function using a computing resource indicated by the configuration information.

16. The method of claim 15, further comprising:
determining a duration for executing the modified task as the serverless function; and
determining accounting information for a user of the modified task based on the duration.

17. The method of claim 11, further comprising:
generating a table-based script statement, the table-based script statement comprising a table with a plurality of extract-load-transform (ELT) scripts.

18. The method of claim 17, further comprising:
configuring the dynamic data processing statement to include a call to one or more ELT scripts of the plurality of ELT scripts.

19. The method of claim 18, further comprising:
executing the modified task based on performing a plurality of data processing operations associated with a data processing pipeline, the plurality of data processing operations configured by the one or more ELT scripts.

20. The method of claim 11, wherein the dynamic data processing statement is a dynamic structured query language (SQL) statement, the dynamic SQL statement including at least one SQL statement associated with a post-processing task, and the method further comprising:
executing the at least one SQL statement to perform the post-processing task.

21. A computer-storage medium comprising instructions that, when executed by one or more processors of a machine, configure the machine to perform operations comprising:
retrieving configuration information associated with periodic processing of a database table;
detecting a task associated with the database table, the task specifying at least one data processing operation to transform data stored in the database table and metadata of the at least one data processing operation, the metadata specifying at least a period for the periodic processing, and the at least one data processing operation configured to perform a single call into the database table based on the metadata;
generating a dynamic data processing statement, the dynamic data processing statement including multiple data processing statements associated with the periodic processing of the database table; and
revising a portion of the task to generate a modified task, the revising including replacing the at least one data processing operation with the dynamic data processing statement, the modified task further including the configuration information associated with the periodic processing and the metadata indicating at least the period for the periodic processing.

22. The computer-storage medium of claim 21, the operations further comprising:
executing the multiple data processing statements during execution of the modified task.

23. The computer-storage medium of claim 22, wherein the configuration information within the modified task comprises scheduling information associated with a pre-configured schedule, and the operations further comprising:
executing the multiple data processing statements periodically, at the pre-configured schedule.

24. The computer-storage medium of claim 22, wherein the configuration information within the modified task comprises virtual warehouse information indicating a computing resource available prior to the generating of the modified task, and the operations further comprising:
executing the multiple data processing statements using the computing resource.

25. The computer-storage medium of claim 21, the operations further comprising:
executing the modified task as a serverless function using a computing resource indicated by the configuration information.

26. The computer-storage medium of claim 25, the operations further comprising:
determining a duration for executing the modified task as the serverless function; and
determining accounting information for a user of the modified task based on the duration.

27. The computer-storage medium of claim 21, the operations further comprising:
generating a table-based script statement, the table-based script statement comprising a table with a plurality of extract-load-transform (ELT) scripts.

28. The computer-storage medium of claim 27, the operations further comprising:
configuring the dynamic data processing statement to include a call to one or more ELT scripts of the plurality of ELT scripts.

29. The computer-storage medium of claim 28, the operations further comprising:
executing the modified task based on performing a plurality of data processing operations associated with a data processing pipeline, the plurality of data processing operations configured by the one or more ELT scripts.

30. The computer-storage medium of claim 21, wherein the dynamic data processing statement is a dynamic structured query language (SQL) statement, the dynamic SQL statement including at least one SQL statement associated with a post-processing task, and the operations further comprising:
executing the at least one SQL statement to perform the post-processing task.
